(19) United States
(12) Patent Application Publication
(10) Pub. No.: US 2008/0169417 A1
(43) Pub. Date: Jul. 17, 2008

(54) COMPACT HIGH PERFORMANCE CHEMICAL DETECTOR

(75) Inventors: Daniel R. Cohn, Cambridge, MA (US); Leslie Bromberg, Sharon, MA (US)

Correspondence Address: CHOATE, HALL & STEWART LLP, TWO INTERNATIONAL PLACE, BOSTON, MA, 02110, US

(73) Assignee: MASSACHUSETTS INSTITUTE OF TECHNOLOGY, Cambridge, MA (US)

(21) Appl. No.: 11/747,276

(22) Filed: May 11, 2007

Related U.S. Application Data
(60) Provisional application No. 60/747,034, filed on May 11, 2006.

(51) Int. Cl. H01J 49/26

(52) U.S. Cl. 250/288

(57) ABSTRACT

Ion mobility spectrometer. The spectrometer includes an enclosed region having a gas with a selected chemical species contained therein. An energy source ionizes the gas and the chemical species. Spaced apart electrodes generate high frequency and DC electric fields across the enclosed region and circuitry is provided for generating voltage waveforms on the electrodes. The voltage waveforms include a symmetric RF field to minimize ion loss and to prevent clustering of the ions with water molecules during an ion buildup phase. A DC and asymmetric, non-uniform RF field is provided to separate and focus the ions in the region during an ion separation phase. Finally, a changing DC or RF field causes the ionized chemical species to move to the electrodes and read-out circuitry responds to current in the electrodes to indicate the presence and/or amount of the chemical species.

This application claims priority to provisional application Ser. No. 60/747,034 filed May 11, 2006, the contents of which are incorporated herein by reference.

### BACKGROUND OF THE INVENTION

This invention relates to chemical detectors, and more particularly to a chemical detector utilizing smoke detector technology in combination with ion mobility spectrometer technology.

There is a need for a stationary chemical detector for a use such as explosives detection. Such a detector should have high sensitively, low cost, low number of false positives, long life without the need for consumables, and low maintenance. Such a device can be used for airport security screening, for example.

Ion mobility spectrometers have the potential to fulfill this need. However, devices currently on the market are expensive, large in size, and require maintenance. They also use consumables in the form of reagents that are used to increase sensitivity and minimize false positives. Although there has been progress in developing smaller devices, mainly employing the FAIMS (Field Asymmetry Ion Mobility Spectrometer) or DMS (Differential Mobility Spectrometer) approach (such as that from Sionex, Waltham, Mass.), these devices have low sensitivity and are still relatively complex requiring flowing gases. They have issues transporting efficiently the ions generated in the ionization region to the separating region, which has high values of electric fields. The poor transmission results in low detector currents and decreased sensitivity.

Ion mobility spectrometers, of course, require that ions be created. Although the chemistry of atmospheric pressure ionization is not fully understood, the presence of large amounts of water in the gas affects the ionization process. Water has a high polar moment and readily clusters onto ions. When ions are formed in the absence of reagents (such as ammonia for positive ions and chlorinated compounds for negative ions), the ionization process is thought to occur through several steps until the charged particles (reactive ions) are protonated water molecules (for positive ions), or oxygen or carbon dioxide molecular ions (for negative ions). The process then continues until the negative charge is transferred to the most electronegative gas (the molecules with the highest electron affinity), and the positive charge to the most tightly bound positive ions, known as the product ions. Heavy ions from chemical agents, explosives, and narcotics usually have properties that preferentially grab the available charge and can then be detected.

Water molecules can cluster around the ions thereby decreasing or preventing chemistry. The clustering decreases and even prevents the kinetics that result in the generation of product ions and the ion charge transfer chemistry to the state with minimum energy.

Present day Ion Mobility Spectrometers control the atmosphere either by removing the water using a dryer or through the use of a membrane. In either case, such units require flowing gases that demand pumps and filters, thereby making the device larger and more complex.

As mentioned above, ion mobility spectrometers need a source of ionization to create ions. Smoke detectors utilize a small source of radioactive material to achieve ionization. A suitable source is Am²⁴¹. This material decays by emission of an alpha particle with an energy of ˜5 MeV. The range of the alpha particle (the distance that it travels before slowing down) is about 2 cm in air at room temperature and ambient pressure. The intensity of this alpha source is on the order of 1 microCu. For this reason, smoke detectors are safe for handling and installation.

In a large number of explosives detectors the instrument samples vapors from vaporized particulates, as some of the explosive materials have low vapor pressure. These particulates are captured and then vaporized. IMS devices with built-in particulate samplers could be easily adapted for detecting smoke particulates, which when combined with monitoring of partial combustion products by the ion sensor could result in an improved fire detector. An object of the present invention is a device that integrates the use of smoke detector ionization technology with a chemical sensor. In order to minimize required certification issues, a geometry similar to that of present day smoke detectors is used.

### SUMMARY OF THE INVENTION

The ion mobility spectrometer of the invention includes an enclosed region having a gas containing a selected chemical species contained therein. An energy source is provided to ionize the gas and the chemical species. Spaced apart electrodes generate high frequency and DC electric fields across the enclosed region and circuitry is provided for generating voltage waveforms on the electrodes. The voltage waveforms include a symmetric or asymmetric strong RF field to prevent clustering of the ions with water molecules during an ion buildup phase. The strong RF field also decreases the ion-ion recombination, both through the selective elimination of the one charge of ions (as described below), as well as by providing energy to the ions, which decreases recombination rates. A DC and a symmetric, non-uniform RF field separates and focuses the ions in the region during an ion separation phase. A changing DC or RF field causes the ionized chemical species to move to the electrodes and read-out circuitry responds to current to indicate the presence and/or amount of the chemical species.

In a preferred embodiment, the energy source is a radioactive material such as Am²⁴¹. The energy source could be other radioactive substances, such as Ni⁶³ or alternatively it could be an e-beam. In addition to decreased regulatory constrains because of the lack of radioactivity, an electron beam has the advantage that the electron current can be modified and even turned off, increasing flexibility of the device. Control of the ionization rate can increase the signal to noise ratio of the ion collection process, as will be described below.

It is preferred that the frequency of the RF field is in the range of approximately 100 KHz and 2 MHz. It is preferred that the electric fields be spatially non-uniform. In order to sample selected chemical species, the enclosed region includes openings to sample ambient air.

### BRIEF DESCRIPTION OF THE DRAWING

FIGS. 1(a) and 1(b) are cross-sectional views of an embodiment of the chemical detector disclosed herein.

FIG. 2 is a graph of RF voltage versus time during the charge buildup phase.

FIG. 3 is a schematic diagram of the use of combined RF and DC-compensating fields for ion separation during the ion separation stage.

FIG. 4 includes graphs showing ion separation by balance of drifts in a DC-compensation field and a strong RF field.

FIG. 5 shows the spatial dependence of the ion DC-compensation drift and RF drifts on the left and illustrative ion motions during and after focusing is shown on the right.

FIGS. 6a-e are graphs that illustrate several possible means to drive the ions to the collecting electrode during the ion collection phase.

### DESCRIPTION OF THE PREFERRED EMBODIMENTS

The present invention addresses several disadvantages of present day chemical sensors by utilizing technology incorporated in smoke detectors. Although other ionization sources could be used such as e-beams, the advantage of a radioactive source is that it is inexpensive, long lasting and requires no maintenance. An example is Am²⁴¹ that is the radioactive source in smoke detectors. While a chemical detector that uses a radioactive source will require a radioactive stamp, by keeping the source within the design parameters of smoke detectors will facilitate implementation.

Ion chemistry that results in the formation of large water clusters can interfere with the sensitivity of conventional mobility spectrometer devices. The undesired clustering can be modified or prevented by the application of strong electric fields. The electric fields provide energy preferentially to the ions and at a relatively high value of ion energy the formation of large clusters is minimized.

The process of ion analysis on which the present invention is based consists of three phases: an ion buildup phase, an ion separation phase and an ion collection phase. It may be possible to combine the ion buildup and ion separation phases.

A chemical detector according to an embodiment of the invention is shown in FIGS. 1(a) and 1(b). A chamber 11 in device 10 includes radioactive sources 12 and 14 on inside surfaces. A suitable radioactive source is Am²⁴¹ that emits alpha particles. Breathing holes 16 and 18 permit sampling of ambient air or from vaporized particulates. The alpha particles from the radioactive sources 12 and 14 interact with gas inside the chamber 11, ionizing it. Opposing electrodes 20 and 22 flank the area where alpha particles generate ions.

Ion chemistry occurs in the interior space of the device 10. As showing in FIG. 1a, the collector electrode 22 is within the chamber 11. Alternatively, as showing in FIG. 1b, the collector electrode 22 may be outside the chamber 11 and downstream from a partially transparent electrode.

The operation of device 10 will now be described. The first phase of operation is referred to as the ion buildup phase. The voltage waveform shown in FIG. 2 is applied across the electrodes 20 and 22. In order to minimize the loss of ions during the charge buildup phase, a symmetric RF field may be used (without DC compensation field). The use of the symmetric electric field shown in FIG. 2 prevents non-linear drifts, minimizing ion loss. A suitable frequency is in the range of approximately 100 KHz to several MHz (such as, for example, 2 MHz). The electric field should be higher than approximately 5 kV/cm and ideally higher than 10 kV/cm. High frequency is used to minimize the distance that the ions travel during a cycle, while a short electrode gap is preferred to minimize the required value of the voltage. Both positive and negative ions are stored in the gap between the electrodes 20 and 22.

Ion concentration at steady state in the device 10 is limited by ion-ion recombination. For the present application, steady state conditions occur in times on the order of a few milliseconds. The chemistry of formation of product ions is fast, and the charge is expected to be distributed near steady state at the end of the ion buildup phase. Additional time can be provided by extending the ion buildup phase if necessary.

Relatively high values of the electric field are required to prevent a large degree of clustering of the ions with polar water molecules. The relevant parameter for this process is the value of the electric field divided by the number density of gas molecules known as the Townsend parameter (E/n, where E is the electric field and n is density). Since the device 10 is likely to operate mainly at atmospheric pressure, n is constant and thus electric field values can be used instead. Values of E/n on the order of 1-10 Townsends are typical.

Because of ion-ion recombination and because the electric fields being used are large, space charge effects are small. Thus, ion motion can be investigated with single ion orbits calculations. Such calculations can be used for the charge buildup phase as well as for the subsequent phases.

After the ions are generated, they are separated by the combined use of a DC field and an asymmetric RF field. Ion focusing is achieved by the use of asymmetric non-uniform electric fields, achieved by changing the waveform of the RF voltage. In this case, the waveform is not as shown in FIG. 2, but the positive field is higher (lower) than the negative field, and the average RF field is zero by making the duration of the positive phase shorter (longer) than the negative phase. The level of asymmetry is defined as the ratio between the highest field to the lowest field. Focusing in a geometry with electrodes in a cylinder-to-cylinder configuration have been described. See, R. Guevremont and R. W. Purves, “Atmospheric pressure ion focusing in a high-field asymmetric waveform ion mobility spectrometer”, RSI 70 n. 2 1370 (1999). The contents of this paper are incorporated herein by reference. The usual ion mobility spectrometer applications of the FAIMS or DMS technologies involve the separation of the ions as they drift due to flowing gas as opposed to the present applications in which the ions are separated in the same chamber where they are generated and without the presence of a flowing gas.

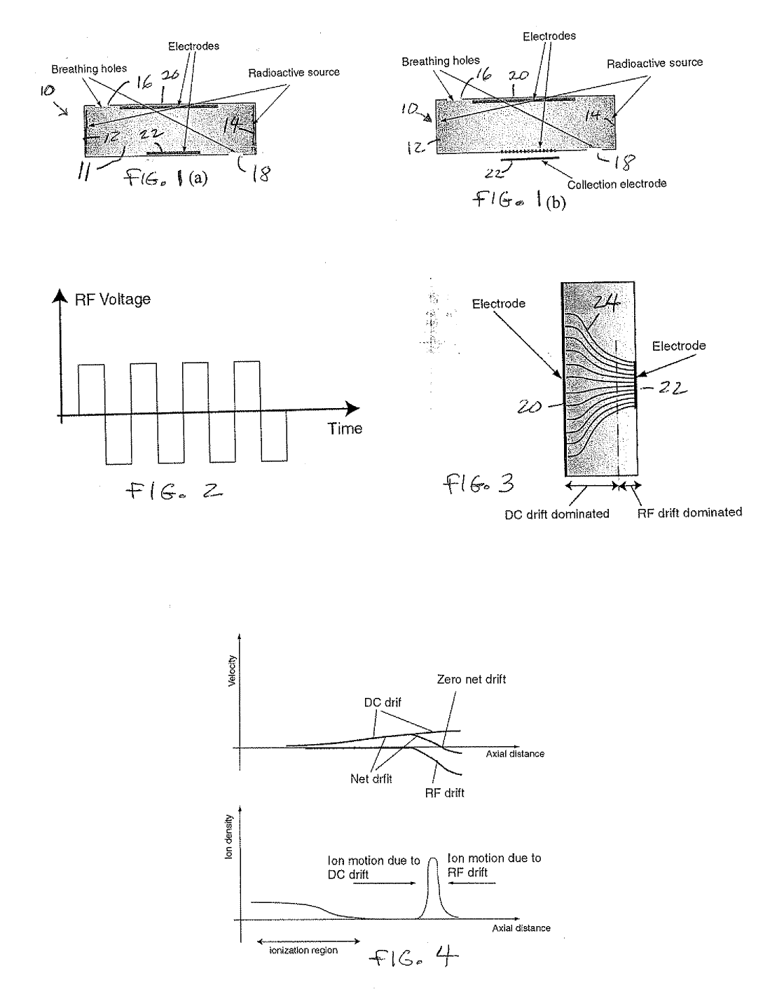

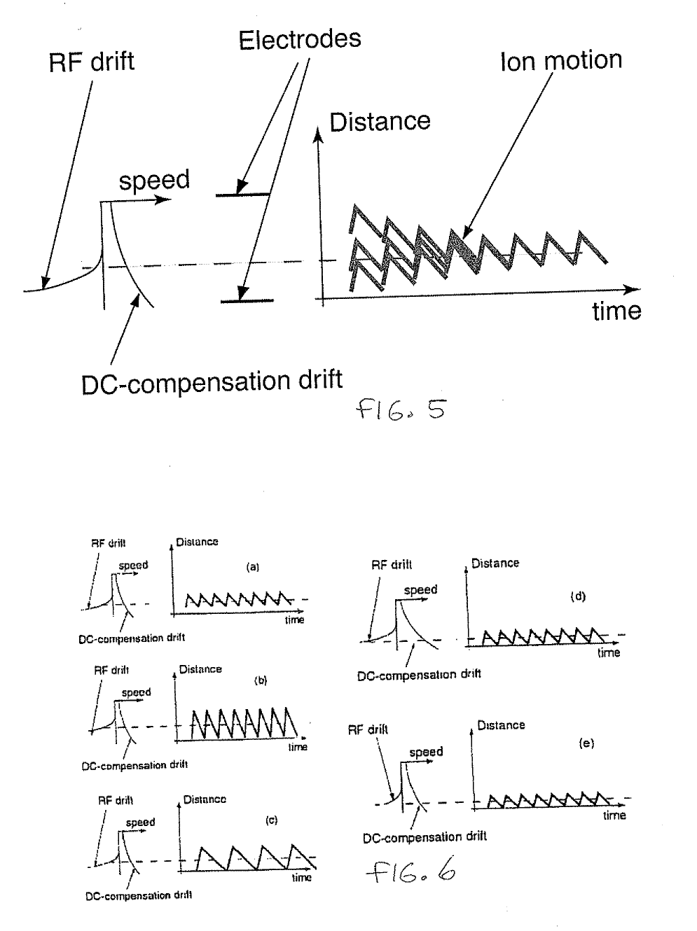

The geometry of the device disclosed herein does not have to be cylindrical as many geometries that generate non-uniform fields can be used. FIG. 3 shows a schematic of a “pillbox” geometry in which the electrodes 20 and 22 are parallel but of different dimensions thereby generating a non-uniform field. Other possible configurations that results in non-uniform fields are spherical or hemispherical geometries. Electric field lines 24 are also shown in FIG. 3. On the left side of the equilibrium position of FIG. 3, the DC compensation field drift dominates (pushing ions to the right) while to the right, the RF field drift dominates (pushing ions to the left), thus resulting in a stable equilibrium, as described below.

The separation process can be described using a simple mathematical model. The DC drift depends linearly on the DC compensation field:

v_{DC}_{_{—}}_{comp}=μE_{DC}_{_{—}}_{comp}

Here μ is the mobility and E the electric field. The RF field induced ion drift depends non-linearly on the AC field gradient:

v_{RF}˜dμ/dE(E₊−E₋)E₊(Δt₊/(Δt₊+Δt₋))=dμ/dE(E₊−E₋)/(E₊+E₋)E₊E₋

By applying an RF field that results in a drift that is opposite to the DC compensation field drift, a balance can be achieved. In a non-uniform field the gradient of the ion drift due to the DC field is different from the gradient of the drift due to the RF field. In order for a stable situation to be generated, the gradient of the velocity of the RF field has to be in the same direction as the velocity due to the RF drift. Stable orbits (i.e., focusing) for the conditions in FIG. 4 are achieved when the following condition applies:

(dv_{DC}/dx+dv_{RF}/dx)<0

If the sign of the above relation is opposite a defocusing condition results where the ions are actually pushed away from the equilibrium point.

The focusing process is schematically shown in FIG. 4. The DC drift is positive and depends exclusively on the value of the DC electric field. The RF drift, in contrast, depends approximately on the square of the electric field, and thus has a much steeper behavior.

The size of the ion cloud is determined by the focusing due to the difference between the gradient of the drift due to the compensating DC field and the gradient of drift due to the RF fields, and the defocusing due to diffusion and space charge. The focusing due to the gradients results in highly concentrated ions, and in the absence of diffusion and space charge, it would be in an infinitesimal region of space that oscillates because of the RF nature of the electric field. This accumulation (focusing) provides for additional selectivity.

FIG. 5 shows the ion dynamics and the ion drift velocities within the electrode gap. Spatial dependence of the ion DC-compensation drift and RF drifts are shown on the left. Illustrative ion motion during and after focusing is shown on the right.

Ion separation takes place in the same chamber as the ion generation. This feature further distinguishes the embodiment from the previous art. As in the case of the charge buildup phase, the use of large RF fields prevents the formation of large clusters during the ion separation phase.

Non-uniform fields can be generated between cylinders, as in the case of Guevremont. Alternatively, the fields can be generated between planar electrodes of different sizes. Multiple methods of generating these fields exist.

Because of the higher ion mobility of the reactive ions, the bulk of the reactive ions can be removed from the gap during the separation phase. Not all of them can be removed because they may be continuously generated, as in the case of a radioactive source. In the case of an electron beam, it is possible to shut off the electron current during this phase, in which case all the reactive ions can be removed. Because the separation phase is short, there would be few new reactive ions produced. The ions with the opposite polarity to those that are being separated have DC drifts that are in the opposite direction from the RF orbits, and thus are removed. It should be noted that accumulation only occurs for those ions of a given dependence of the mobility with respect to the electric field (that is, the sign of dμ/dE). While ions of a given polarity that have the same sign of dμ/dE will be separated, the others will be driven to the walls. However, it is possible to have ions of opposite charge, but with opposite sign of dμ/dE, be separated at the same time. In any case, it is likely that most of the ions of the opposite sign are removed, minimizing the ion-ion recombination and increasing the number of product ions of interest, thus increasing the sensitivity of the instrument.

In another embodiment of this invention, both the ion build-up and the ion separation phases overlap. The reactive ion confinement time in the chamber can be made longer than the ion chemistry time, and thus large numbers of product ions can be built up by simply extending the ion build-up/separation phase, in the absence of large concentrations of ions of the opposite species (keeping the ion-ion recombination to a minimum). This scheme thus simplifies the detection of the ions, because there are much larger ion currents, allowing not only for simpler electronics for the detector, but also for increased sensitivity.

Finally, during ion collection phase the charge in the chamber is removed and measured. The ions collected are the result of three sources: the alpha particles (whose energy is such that the applied electric fields do not have any effect on the ion motion), the reactive ions generated by the alpha particles during the ion collection phase and that have not been removed, and finally the ions that have been separated and focused. There are two means of collecting the ions: if the ions of interest have sufficient spatial separation, then just swiping the ions from the inter-electrode gap is sufficient. This process results in a much larger current than time-of-flight ion mass spectrometers or that of FAIMS or DMS devices.

However, it is more likely that the ions will not separate enough spatially. Then, the current collection can be done by changing the focusing parameters so that the ions' spatial distribution changes. The separated product ions will be removed from the gap when their orbits intersect the electrode. Thus, one type of separated product ions can be removed from the chamber separately from the other, which have different mobilities and differential mobilities, thus with different orbits.

There are several means by which the separated product ions can be driven to the electrode. FIG. 6 illustrates these means. FIG. 6a shows the equilibrium motion of a class of ions at the end of the separation region. The goal is to move the bottom edge of the ion motion to the electrode.

There is a tradeoff between the extent of the chamber in the direction of the RF/DC velocity direction and the magnitude of the electric field. Multiple ion types (from different compositions) can coexist in the inter-electrode region, with different values of RF and DC drifts, each ion species satisfying the relation that the DC compensating voltage drift balances the RF induced drift. The overlap of the ion measurement can be avoided by selecting a small size of the chamber or alternatively, by decreasing the RF frequency, to prevent this possibility. In the ideal case, the selected ion species has a motion such that the ions nearly touch one or both of the electrodes. In this manner, other species are eliminated by having their orbits be such that the ions are collected by one of the electrodes, even though their equilibrium point (their focusing point) exists between the electrodes. This method can increase very substantially the selectivity of the device.

The ion collection phase can be performed by slowly changing the DC compensation voltage (as in conventional FAIMS or DMS devices), increasing/decreasing the RF field or decreasing the frequency of the RF fields. The ion orbits then start shifting towards one of the electrodes and ions of the same species are collected almost at the same time (because of the highly localized cloud due to the ion focusing). This technique could be used even if multiple species, with different equilibrium points, exist within the spectrometer. This can be done by a) increasing the value of the RF electric field (shown in FIG. 6b); b) decreasing the RF frequency of the waveform, at fixed fields, resulting in increased displacements, as shown in FIG. 6c; increasing the value of the DC compensation field, resulting in a displacement of the equilibrium position, as shown in FIG. 6d; decreasing the value of the RF fields, as shown in FIG. 6e. In any of these methods, different types of ions will be collected for different sets of DC compensation fields and/or RF fields, and thus result in selectivity.

The sensitivity of the device (and the signal to noise ratio) can be increased by the use of controlled ionization sources, such as electron beam, x-rays or coronas as a result of the elimination of the background current due to the generation of the reactive ions during the ion collection phase. This current can be eliminated if the ionization source is shut-off during the ion collection phase.

The electric fields are high, but with high enough frequency so that the ion drift during a cycle is small compared with the thickness of the chamber, so that the high energy of the ions from the electric field can be used to modify the chemistry of the instrument, preventing clustering with water and other polar molecules, increasing the sensitivity of the device under less than ideal conditions (such as with high relative humidity, during the presence of highly polar constituents or hydrocarbons, and when devices are operated near the exhaust of internal combustion engines).

Frequencies should be on the order of 100 kHz to several MHz (such as 2 MHz), and the electric fields should be higher than 5 kV/cm, and ideally higher than 10 kV/cm.

It should be noted that, unlike the case of FAIMS, the ion drift is aligned in the direction of the RF field (in the same direction or opposite to it). In the usual FAIMS devices, the ion motion (due to the gas flowing) is in the direction perpendicular to the RF field.

The ion build-up, separation and collection phases in the novel spectrometer occur in the same chamber, eliminating the ion loss during transfer from one region to the other as is needed in either conventional time-of-flight IMS devices or FAIMS or DMS devices, and eliminating the need for flowing gases.

The present device operates in a mode that is batch-like, rather than continuous as in the case of FAIMS. However, after ion separation multiple ions can be identified during the ion collection phase.

Although this disclosure concentrates on the use of alpha particle emitting radioactive sources, the invention is not limited by the nature of the source. In particular, beta-emitting radioactive sources could also be used, as well as controlled ionization sources, such as electron beams, x-rays, photons or coronas.

The instrument could be combined with a smoke detector to make an improved fire detector. The smoke detector part could use the ion current during the ion build up phase to monitor for particulates indicating the presence of combustion. The ion detection through the ion mobility spectrometer could be also used to monitor products of incomplete combustion and thus detect the early phases of combustion.

It is recognized that modifications and variations of the invention disclosed herein will be apparent to those of ordinary skill in the art and it is intended that all such modifications and variations be included within the scope of the appended claims.

What is claimed is:

1. Ion mobility spectrometer comprising:
an enclosed region including gas having a selected chemical species contained therein;
an energy source adapted to ionize the gas and the chemical species;
spaced apart electrodes for generating high frequency and DC electric fields across the enclosed region; and
circuitry for generating voltage waveforms on the electrodes, the voltage waveforms including:
a symmetric RF field to minimize ion loss and to prevent clustering of the ions with water molecules during an ion buildup phase;
a DC and asymmetric, non-uniform RF field to separate and focus the ions in the region during an ion separation phase;
a changing DC or RF field causing the ionized chemical species to move to the electrodes; and
read-out circuitry responsive to current to indicate presence and/or amount of the chemical species.

2. The spectrometer of claim 1 wherein the energy source is a radioactive material.

3. The spectrometer of claim 2 wherein the material is Am²⁴¹.

4. The spectrometer of claim 1 wherein the energy source is an e-beam.

5. The spectrometer of claim 1 wherein the frequency of the RF field is in the range of approximately 100 KHz and 2 MHz.

6. The spectrometer of claim 1 wherein the electric fields are spatially non-uniform.

7. The spectrometer of claim 1 wherein the enclosed region includes openings to sample ambient air.

8. The spectrometer of claim 1 that uses non-uniform electric fields in order to increase selectivity through bunching of the iron cloud through the non-uniform electric fields.

9. The spectrometer of claim 8 wherein the spectrometer has cylindrical geometry and ion cloud motion is in a radial direction.

10. The spectrometer of claim 8 wherein the device has spherical geometry and the ion cloud motion is in the radial direction.

11. The spectrometer of claims 1-10 wherein the ion buildup and the ion separation phases overlap, with ion accumulation and separation in the presence of reduced number of ions of the opposite charge.

12. The spectrometer of claims 1 and 4-11 wherein the ionization source is shut-off during the collection phase.

13. The spectrometer of claims 1-12 wherein the device is combined with a particulate sensor for the detection of smoke, while the ion sensor is used to measure products of combustion, resulting in an improved fire detector.

14. The spectrometer of claims 1-12 wherein the device is combined with a particulate collector and vaporizer in order to introduce the sample into the sensor.
